(19) United States
(12) Patent Application Publication
(10) Pub. No.: US 2009/0218714 A1
(43) Pub. Date: Sep. 3, 2009

(54) APPARATUS

(76) Inventors: Ping Li, Basking Ridge, NJ (US); Mark Robert Mecadon, Basking Ridge, NJ (US); Jiahao Zhu, Whippany, NJ (US)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 12/392,344

(22) Filed: Feb. 25, 2009

Related U.S. Application Data
(60) Provisional application No. 61/032,580, filed on Feb. 29, 2008.

(51) Int. Cl. B29C 43/02; B28B 3/00

(52) U.S. Cl. 264/101; 425/363; 425/405.1

(57) ABSTRACT

The invention relates to apparatus for filling a cavity during production of a pharmaceutical dosage form. The apparatus comprises a cavity open at an upper surface and closed at a lower surface. The lower surface is defined by an initial layer of powder. A powder source and a fluid pump are also provided. The fluid pump is arranged to draw gas away from the cavity such that the gas pressure within the cavity is reduced below the ambient gas pressure before the cavity is filled to a predetermined fill level with powder from the powder source.

The invention relates to apparatus for filling powder into a cavity during the production of a pharmaceutical dosage form such as a tablet. The invention is of particular application to the creation of a multiple layer tablet. The invention extends to a method for filling a cavity with powder during the creation of a pharmaceutical dosage form such as a tablet.

It is a known process to fill a cavity with powder during the manufacture of a pharmaceutical dosage form. The powder being filled into the cavity is typically a pharmaceutical powder formulation and the fill weight determines the dose of a pharmaceutically active component of the powder formulation in the final dosage form. The amount of powder within the cavity must be controlled as variability in the fill weights can result in a variable dose of active compound being provided. Cavities can be filled by weight, which can involve live measurements of the weight and feedback to a powder dispenser to determine and control the fill weight. In a different embodiment cavities can be filled each time to a predetermined fill height, for example the top of the cavity, as this results in a consistent volume being filled each time and this can be approximated to a using a consistent fill weight.

In a capsule filling process the cavity may be one portion of a capsule which, after filling, is attached to a second capsule portion to form a complete capsule containing the dispensed powder. In a tableting process a punch can be used to compress the powder within the cavity, or die, to form a tablet.

The present invention provides apparatus for filling a cavity during production of a pharmaceutical dosage form, the apparatus comprising a cavity open at an upper surface and closed at a lower surface, a powder source and a fluid pump, the lower surface being defined by an initial powder layer, the fluid pump being arranged to draw gas away from the cavity such that the gas pressure within the cavity is reduced below the ambient gas pressure before the cavity is filled to a predetermined fill level with powder from the powder source.

It has been found that a reduction in the gas pressure within the cavity results in a reduced variance in the fill weight in the cavity when the cavity is filled with powder. This means that the powder dosage in the dosage form can be more accurately controlled which results in less wastage and a greater accuracy in the delivered dose of pharmaceutically active ingredient. It has further been found that the reduced cavity gas pressure results in a higher fill weight.

The pharmaceutical dosage form can be a tablet. The cavity can be a die cavity in a tableting process or other suitable cavity, which is filled from a powder source during the creation of a pharmaceutical dosage form. In one embodiment the cavity is a die cavity of a tableting apparatus and the dosage form being manufactured is a multi-layer tablet, especially a two-layer tablet.

The initial layer of powder can be partially compacted and can comprise one or more layers of powder. In one embodiment the initial layer comprises a single layer of partially compacted powder of a different formulation to that being used for the new layer being created. The formulations may comprise different active ingredients. Each layer may comprise one or more pharmaceutically active compounds and/or one or more pharmaceutically acceptable excipients. In a two, or more, layered tablet each layer may comprise a different pharmaceutically active compound, or one layer may comprise no pharmaceutically active compound.

The powder source may be any suitable source of powder from which a cavity can be filled. The cavity may be filled under gravity such that the powder falls into the cavity substantially under gravity alone. The powder source can be arranged to stop filling the cavity when a predetermined fill level is reached. This can be achieved using fill level sensors and feedback control as is known. The powder source can also be arranged to substantially fully fill the cavity. In one embodiment there is provided a cavity having a substantially flat and substantially horizontal upper surface. The powder is deposited by the powder source into the cavity until the cavity is at least filled to a level substantially equal to that of the upper surface. Powder that is located above the plane of the upper surface of the cavity is removed so that the volume of the cavity is substantially filled with powder.

A scraper or other tool moving relative to the cavity substantially along the upper surface of the cavity can be used to remove the excess powder that extends above the plane of the upper surface of the cavity. It is possible for the lower surface of the cavity to be raised after the filling process, but before an excess powder removal process, in order to force at least some powder out of the cavity which powder can then be removed.

The actual weight of powder within the cavity will vary depending upon the degree of packing of the powder formulation into the cavity. The powder formulation dispensed into the cavity will not pack perfectly into the volume and may fill the volume at different rates depending upon powder and ambient conditions. The particles of the powder will pack into the cavity volume leaving spaces between the particles, these spaces can be referred to as interstitial spaces. It is assumed that the higher fill weight achieved with the lower pressure in the cavity is due to enhanced filling and packing of the powder resulting in a reduced interstitial volume.

The fluid pump is used to draw gas away from the cavity and thereby reduce the gas pressure therein below the ambient pressure. The ambient pressure is the prevailing atmospheric pressure in the region surrounding the apparatus upon which the fluid pump does not have a significant effect. The fluid pump can be any suitable form of pump capable of moving a gas away from the cavity. The fluid pump can be a vacuum pump. In one embodiment the fluid pump is arranged to draw gas away from the cavity and to reduce the gas pressure therein below the ambient pressure and to maintain said reduction in gas pressure. This can be achieved through the use of sealing apparatus to substantially enclose at least the cavity and reduce the gas pressure within the enclosed volume, in which case the fluid pump can be operated for a short time and then the enclosure substantially sealed. In another embodiment the fluid pump is run substantially continuously in order to maintain the reduction in gas pressure.

In one embodiment the cavity passes through an inlet seal and is then subjected to the action of the fluid pump to reduce the pressure therein. Once the cavity is filled, the filled cavity can then pass through an outlet seal before or after compaction of the cavity contents. In such an embodiment the volume between the seals is the volume upon which the fluid pump is considered to act and the atmosphere outside said seals is considered the ambient atmosphere. The seal need not be a substantially airtight seal, but should restrict the passage of air, or other ambient gas, towards the cavity such that the air pressure within the cavity is reduced below ambient pressure, at least during the filling of the cavity. The outlet seal could be integral with the scraper for removing excess powder material from above the cavity. Further seals which cooperate with the inlet and outlet seals to substantially enclose a volume upon which the fluid pump acts can also be provided.

The pressure within the cavity may be reduced below the pressure of the ambient atmosphere by at least 1%, or can be reduced by at least 5% or by at least 10%.

The invention extends to a method for creating at least one layer of a multi-layer tablet using tableting apparatus, the apparatus comprising a cavity having open at an upper surface and closed at a lower surface, the lower surface being defined by an initial powder layer, a powder source, a fluid pump and at least one punch, the method comprising the steps:
a. using the fluid pump to draw gas away from the cavity such that the gas pressure within the cavity is reduced below the ambient gas pressure;
b. using the powder source to substantially fill the cavity to a predetermined fill level; and
c. using the at least one punch to compress the powder within the cavity to bind the at initial powder layer and the additional powder together to form a multi-layer tablet.

In one embodiment the cavity has a substantially constant cross section in a direction substantially parallel with the direction in which the powder enters the cavity, in one embodiment this is a direction substantially parallel with the direction of the gravitational force. The at least one punch has an outer perimeter shape that is substantially conformal with the inner perimeter shape of the cavity such that said punch can compress the powder within the cavity substantially evenly across the cross section of the cavity.

The layer created by the method can be a second or subsequent layer of a bi-layer or multilayer tablet. It should be understood that the term multilayer is used herein to include bi-layer (two or twin layer). In this case the base of the cavity can be formed by one or more layers of partially compressed powder material. When the second and/or subsequent layers is/are compressed to form the tablet layer the partially compressed layer/layers is/are further compressed so that the tablet layers bind together to form a substantially solid layered tablet.

In one embodiment an initial layer of a tablet can be formed through the use of a movable lower punch. A substantially flat horizontal table is arranged with a lower punch arranged therein such that an upper surface of the punch lies substantially in the plane of the table and substantially fills an aperture in the table. When the lower punch is below a gravity feed powder source powder is fed to the table surface and the lower punch is moved away from the powder source. The movement of the lower punch away from the powder source into the aperture in the table draws powder into a cavity now defined by the upper surface of the lower punch and the inner surface of the aperture in the table. The cavity is substantially filled with powder material and excess powder material located above the plane of the table is removed as previously described.

A punch having a shape corresponding to the shape of the aperture can then be used to compress, at least partially, the powder material to create a cavity above the compressed initial powder layer. In such multilayer tablets the initial layer or layers are not fully compressed and it is difficult to move the lower punch without risking damage to the initial powder layer or layers.

The invention will now be described by way of example only with reference to the following figures in which:

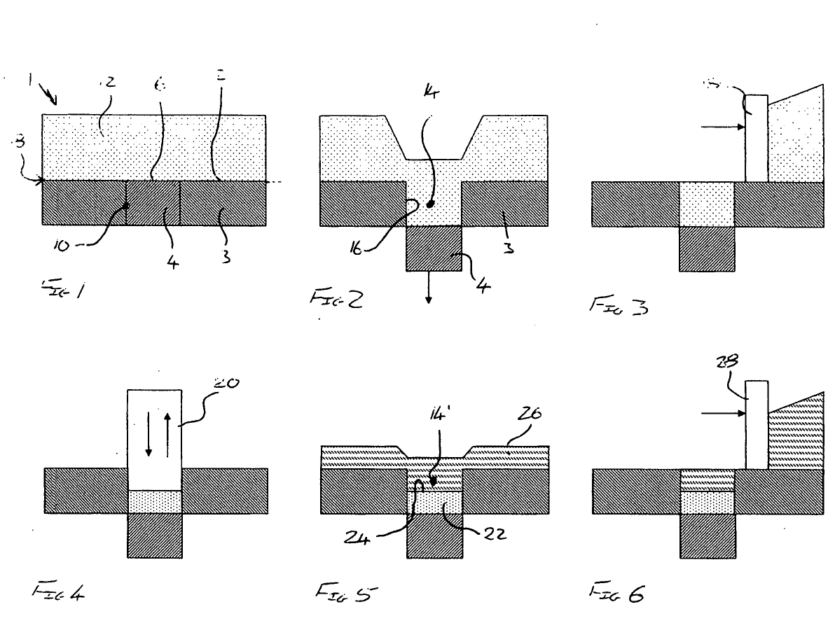

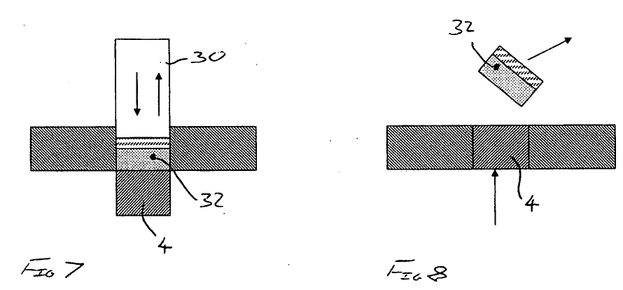

FIGS. 1 to 8 shows a schematic representation of different process steps in the creation of a two layer tablet; and

FIG. 9 shows a schematic representation of apparatus for manufacturing two layer tablets.

FIG. 1 shows apparatus 1 for the creation of a two-layer tablet. The apparatus includes a substantially flat horizontal surface 2 of a table 3 in which is arranged a lower punch 4 such that an upper surface 6 of the punch lies substantially in the plane 8 of table 2 and substantially fills an aperture 10 in the table 2.

Above the table 3 there is located an initial powder source 12, in this case the initial powder source is a bulk powder reservoir filled with a first powder formulation, the height of which is maintained during the filling process. The height of the bulk powder is one factor in determining the force acting upon the powder as it enters a cavity located below the source.

When the lower punch 4 is located below the initial powder source 12, as shown in FIG. 1, the lower punch 4 lowered rapidly. The movement of the lower punch 4 away from the initial powder source 12 into the aperture 10 in the table draws 3 powder into an initial cavity 14 defined by the upper surface 6 of the lower punch 4 and an inner surface 16 of the aperture 10 in the table 3. The initial cavity 14 is substantially filled with powder material with additional, or excess, powder material located above the cavity 14, a top level of which is defined by the substantially flat horizontal surface 2 of the table 3.

Excess powder material which is located above the plane of the table is removed by a scraper 18 as shown in FIG. 3. In this way the predetermined volume of cavity is substantially filled with powder material.

The apparatus includes an initial upper punch 20 having a shape corresponding to the shape of the aperture 10. In this case the punch 20 has a substantially circular cross section and the cavity 14 is substantially cylindrical with a diameter which accommodates the punch 20. The punch 20 is used to compress, at least partially, the powder material to form a cavity 14′ above the compressed initial powder layer 22. The punch 20 is moved into the cavity, compresses the powder material therein to form the compressed initial powder layer 22 and is then moved away from the cavity 14. The cavity 14′ is defined by the upper powder surface 24 of the compressed initial powder layer 22 and an inner surface 16 of the aperture 10 in the table 3.

The gas pressure, in this case the air pressure, in the cavity 14′ is then reduced below the pressure of the surrounding atmosphere before the cavity 14′ is arranged below a second powder source 26 and is filled with powder material from the second powder source 26 under gravity as shown in FIG. 5. Additional, or excess, powder material located above the cavity 14′, a top level of which is again defined by the substantially flat horizontal surface 2 of the table 3.

Excess powder material which is located above the plane 2 of the table 3 is removed by a scraper 28 as shown in FIG. 6. In this way the predetermined volume of cavity 14′ is substantially filled with powder material from the second powder source 26.

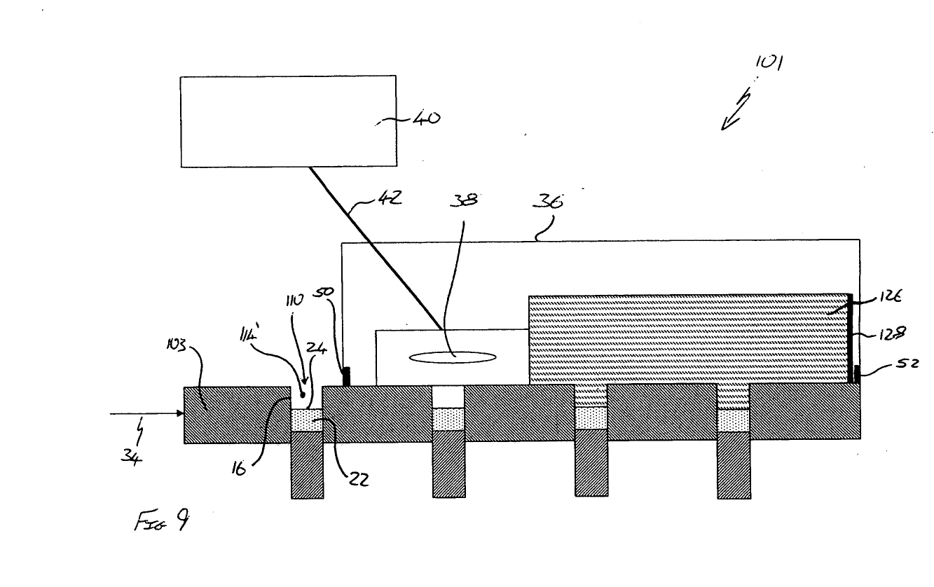

The apparatus includes a punch 30 having a shape corresponding to the shape of the aperture 10, which may be the die 20, or an additional die. In this case the punch 30 has a substantially circular cross section and the cavity 14′ is substantially cylindrical with a diameter which accommodates the punch 30. The die 30 is used to compress the powder material in the cavity 14, which includes both the compressed initial powder layer 22 and the newly introduced powder material, such that the two powder layers bind together to form a tablet 32 as shown in FIG. 7.

The punch 30 is removed from the cavity 14 and the lower punch 4 is moved so that the tablet 32 is ejected as shown in FIG. 8.

FIG. 9 shows a shows a schematic representation of apparatus 101 for manufacturing two layer tablets using the method steps exemplified in FIGS. 1 to 8.

A table 103 is arranged to move through various stations in order. At each station an action in the tablet creation process is performed as exemplified above. In this case the table has already passed through stations which perform the steps of FIGS. 1 to 4 so a cavity 114′ is defined in the table by the upper powder surface 24 of the compressed initial powder layer 22 and an inner surface 16 of the aperture 110 in the table 3.

As shown, the table 103 is moving across the page to the right as indicated 34. The table moves into an enclosure 36 within which there is a fluid pump inlet 38 connected to a fluid pump 40 by a fluid conduit 42. The enclosure 36 is not gas tight and may be integral with the second powder source 126. The gas pressure in the enclosure is reduced below that of the surrounding atmosphere by at least 1%. The enclosure 36 includes an inlet seal 50 through which the cavity passes to enter the enclosure and an outlet seal 52 through which the filled cavity passes to leave the enclosure 36.

As the table 103 passes below the second powder source 126 the cavity 14′ is filled with powder from the second source 126. Excess powder is removed from above the cavity 14′ by a scraper 128 as the table moves towards a die station for final compression of the content of the cavity 14. It should be understood that such a compression action can be preformed before, or after, the cavity leaves the enclosure.

By using a modified fill-O-matic baseplate in which a fluid pump for applying and maintaining the pressure reduction in cavities is coupled to the modified base plate before the table enters the source of the second powder layer the following results can be achieved:

| | | | No pressure reduction | | | With Pressure Reduction | | | | |
|---|---|---|---|---|---|---|---|---|---|---|
| | Weight | | | | Weight | | | Weight | Increase of 2nd | |
| | of 1st | RSD % | Weight | RSD % | of 2nd | Weight | RSD % | of 2nd | layer weight | |
| Tablets | layer | of 1^{st} | of layers | Of 2^{nd} | layer | of layers | Of 2^{nd} | layer | Weight | |
| per hour | (mg) | layer | (mg) | layer | (mg) | (mg) | layer | (mg) | (mg) | % |
| Blend 1 | | | | | | | | | | |
| 50,000 | 558.5 | 0.87 | 862.7 | 1.87 | 304.2 | 936.0 | 0.99 | 377.5 | 73.3 | 24.1 |
| 70,000 | 517.4 | 0.44 | 790.1 | 1.58 | 272.7 | 881.0 | 1.09 | 363.6 | 90.9 | 33.3 |
| Blend 2 | | | | | | | | | | |
| 50,000 | 558.5 | 0.87 | 792.3 | 2.54 | 233.8 | 907.0 | 1.76 | 348.5 | 114.7 | 49.1 |
| 70,000 | 517.4 | 0.44 | 750.1 | 1.48 | 232.7 | 851.3 | 1.72 | 333.9 | 101.2 | 43.5 |
| 100,000 | 509.5 | 0.67 | 725.6 | 2.04 | 216.1 | 783.8 | 1.10 | 274.3 | 58.2 | 26.9 |

Blend 1: Microcrystalline cellulose, Avicel PH102, 99% Magnesium stearate, 1%
Blend 2: Microcrystalline cellulose, Avicel PH101, 99%, Magnesium stearate, 1%

Blend 1 was used as the first layer and blend 1 or blend 2 was used as the second layer. Bi-layer tablets were prepared using a Fetter tablet press 3090 and 21×8.1 mm standard ovaloid bevelled edge punches. The compression speed was 50,000 tph to 100,000 tph. The compression force for the first layer was 1.8 kN. The first layer penetration, which determines the second layer weight, was 8 mm and other compression parameters were kept constant during the studies. The vacuum effect on the second layer tablet weight and the bi-layer tablet weight variation were studied. By reducing the pressure in the cavity below the pressure of the surrounding atmosphere the second layer weight was increased by between 24 to 49% and the bi-layer tablet weight variation was also reduced.

The invention has been described above by way of example only and modifications in detail can be made without departing from the scope of the invention as defined in the claims.

1. Apparatus for filling a cavity during production of a pharmaceutical dosage form, the apparatus comprising a cavity open at an upper surface and closed at a lower surface, a powder source and a fluid pump, the lower surface being defined by an initial powder layer, the fluid pump being arranged to draw gas away from the cavity such that the gas pressure within the cavity is reduced below the ambient gas pressure before the cavity filled to a predetermined fill level with powder from the powder source.

2. Apparatus as claimed in claim 1, in which the pressure in the cavity is reduced by at least 1% below ambient pressure.

3. Apparatus as claimed in claim 2, in which the pressure in the cavity is reduced by at least 10% below ambient pressure.

4. Apparatus as claimed in claim 1, in which the apparatus further includes a punch, the punch being arranged to compress the powder within the cavity causing the added powder and the initial layer of powder to bind together to form a multilayer tablet.

5. Apparatus as claimed in claim 1, in which the apparatus further includes an initial powder source, a table and initial upper punch, the table including an initial cavity and the apparatus arranged such that the initial cavity is substantially filled to an initial predetermined fill height from the initial powder source and the initial punch is then used to at least partially compact the powder in the initial cavity to provide the cavity to be filled from the powder source.

6. Apparatus as claimed in claim 5, in which the initial cavity is formed by a lower punch, the lower punch being located within an aperture in the table, the lower punch being arranged to move into the table and create the initial cavity when the lower punch is located below the initial powder source.

7. Apparatus as claimed in claim 1, in which the cavity passes through an inlet seal to enter an enclosure and, once filled, passes through an outlet seal to leave the enclosure, the fluid pump acting upon the atmosphere within the enclosure to reduce the pressure therein.

8. Apparatus as claimed in claim 1, in which the fluid pump is a vacuum pump.

9. Apparatus as claimed in claim 1, in which the initial layer comprises a single layer of partially compacted powder.

10. Apparatus as claimed in claim 1, in which the pharmaceutical dosage form is a multi-layer tablet in which at least one of the layers includes at least one pharmaceutically active compound.

11. A method for creating at least one layer of a multi-layer tablet using tableting apparatus, the apparatus comprising a cavity having open at an upper surface and closed at a lower surface, the lower surface being defined by an initial powder layer, a powder source, a fluid pump and at least one punch, the method comprising the steps:
a. using the fluid pump to draw gas away from the cavity such that the gas pressure within the cavity is reduced below the ambient gas pressure;
b. using the powder source to substantially fill the cavity to a predetermined fill level; and
c. using the at least one punch to compress the powder within the cavity to bind the at initial powder layer and the additional powder together to form a multi-layer tablet.

12. A method as claimed in claim 11, in which the apparatus further comprises an initial powder source, a table and initial upper punch, at least one of the initial powder source and the powder source including at least one pharmaceutically active compound, the table including an initial cavity and the method further comprises the following initial steps which take place before step (a) of claim 11:
i. using the initial powder source to substantially fill the initial cavity to a predetermined fill height; and
ii. using the initial punch to at least partially compact the powder in the initial cavity to provide the cavity to be filled from the powder source.
